(19) United States
(12) Patent Application Publication
(10) Pub. No.: US 2019/0032624 A1
(43) Pub. Date: Jan. 31, 2019

(54) RING GATE FOR A HYDRAULIC MACHINE AND METHOD FOR CLOSING

(71) Applicant: Voith Patent GmbH, Heidenheim (DE)

(72) Inventor: Martin Schabasser, Pfaffing (AT)

(73) Assignee: Voith Patent GmbH, Heidenheim (DE)

(21) Appl. No.: 16/149,542

(22) Filed: Oct. 2, 2018

Related U.S. Application Data
(63) Continuation of application No. PCT/EP2017/057266, filed on Mar. 28, 2017.

(30) Foreign Application Priority Data
Apr. 6, 2016 (DE) 10 2016 205 647.6

(51) Int. Cl. F03B 11/00; F03B 3/16; F16K 3/30

(52) U.S. Cl. CPC F03B 11/004; F05B 2250/311; F16K 3/30; F03B 3/16

(57) ABSTRACT

A ring gate for interrupting the water flow through the water path of a hydraulic machine having a rotor and a spiral. The ring gate includes a first hollow body extending around the rotor axis and is designed to be moved from an open position into a closed position and back in axial direction, whereby no water flow through the hydraulic machine can occur if the first body is in the closed position. The ring gate includes a second hollow body extending around the rotor axis and is designed to be moved from a first position outside of the water path into a second position within the water path and back in axial direction, wherein the second body has openings in its wall through which water can flow when the second body is in the second position and the first body is not in the closed position.

### CROSS REFERENCE TO RELATED APPLICATIONS

This is a continuation of PCT application No. PCT/EP2017/057266, entitled “RING GATE FOR A HYDRAULIC MACHINE AND METHOD FOR CLOSING”, filed Mar. 28, 2017, which is incorporated herein by reference.

### BACKGROUND OF THE INVENTION

### 1. Field of the Invention

The current invention relates to a ring gate for a hydraulic machine having a rotor and a spiral, for example in turbines of the Francis or Kaplan type and in pump-turbines. The invention moreover relates to a method for closing a ring gate.

### 2. Description of the Related Art

Shut-off devices for hydraulic machines that can be moved between an open position and a closed position, wherein the intermediate positions are only being passed through in order to reach the specified final positions are known in the art as ring gates. This means such ring gates are not used to regulate the through-flow through the hydraulic machine. We refer you in this context to U.S. Pat. No. 3,489,391.

Some of the known problems in the use of ring gates of this type are vibrations may occur when the ring gate is moved into the closed position during an emergency shut-off. Another known problem is that high axial forces act upon the gate when the gate approaches the closed-position. The latter problem requires that the actuators for moving of the ring gate must be designed in such a way that these high axial forces can be overcome, which in turn results in high costs.

What is needed in the art is a ring gate that addresses at least some of the aforementioned disadvantages

### SUMMARY OF THE INVENTION

The present invention provides a device including a ring gate to address the aforementioned problems. It has been discovered that the aforementioned problems are caused by the high non-linearity of the through-flow characteristic of a conventional ring gate. When closing a conventional ring gate, throttling of the through-flow merely occurs over 90% of the travel, whereas the flow change is very strong in the last 10% of the travel. As a result, a compromise is made in closing a conventional ring gate. On the one hand, rapid closure is desired so that the time involving the high vibrations remains short. On the other hand, closure must not occur too rapidly, since this would generate high a pressure surge.

The present invention includes an additional component, wherein the through flow characteristic of the ring gate may be clearly linearized. In conjunction with the newly introduced component, a first phase may be realized during the closing procedure in which the water flow is throttled by forcing the water to flow through the openings of the newly introduced component. In the second phase, said openings are closed so that the water flow is completely stopped.

An embodiment according to the present invention is explained below with reference to drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a cross section view through an exemplary embodiment of a ring gate formed according to the invention;

FIG. 2 shows a cross section view through another exemplary embodiment of a ring gate formed according to the invention;

FIG. 3 shows another cross section view through the embodiment shown in FIG. 1;

FIG. 4 shows another cross section view through embodiment shown in FIG. 2;

FIG. 5 shows a partial side view of an embodiment of a ring gate having openings in a sidewall; and

FIG. 6 shows a flow chart of an exemplary embodiment of a method provided in accordance with the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

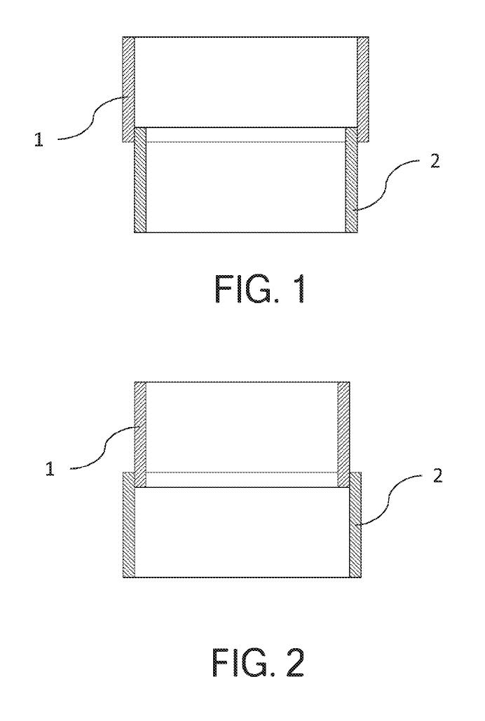

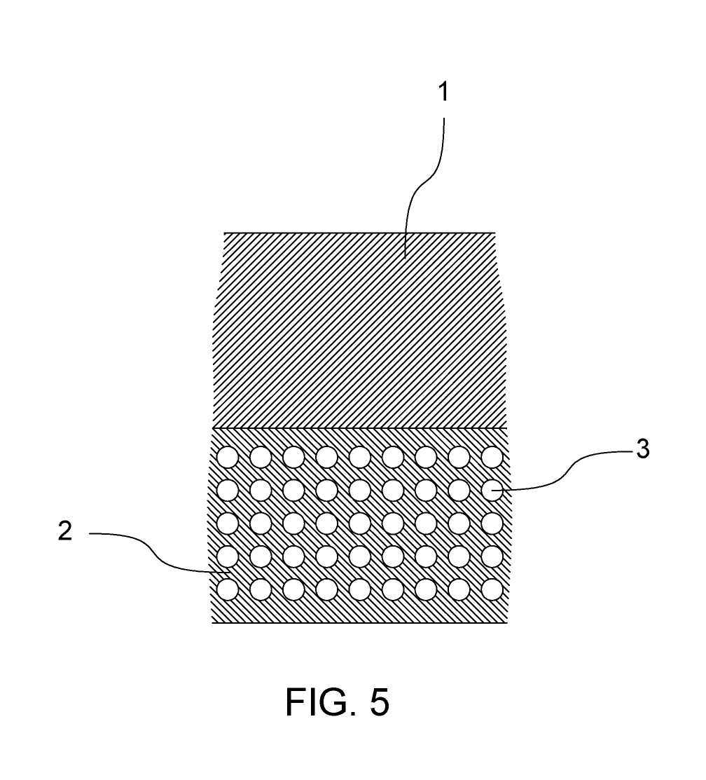

Referring now to the drawings, and more particularly to FIG. 1 there is shown a cross section through an exemplary embodiment of a ring gate formed according to the present invention. The ring gate includes a first body 1. First body 1 is consistent with the closing body on ring gates which are known from the current state of the art. First body 1 extends around the rotor axis and is generally in the embodiment of a hollow cylinder. For closing, first body 1 can be moved in an axial direction, wherein first body 1 is generally in the open position when it is in an upper position. During the closing process it is moved into the lower position in which it shuts off the flow through the hydraulic machine. However, arrangements are also conceivable wherein first body 1 is moved upwards for closing. In FIG. 1, first body 1 is in the open-position. The ring gate according to the exemplary embodiment includes a second body 2 which is generally hollow and cylindrical. Second body 2 may be moved in an axial direction and is arranged coaxially to first body 1, i.e., second body 2 also extends around the rotor axis. Second body 2 can occupy a first (upper) position in an axial direction where it is not located in the water path and can occupy a second (lower) position where it is located in the water path. In FIG. 1, second body 2 is shown in the lower position, that is in the water path. In FIG. 1, second body 2 has a smaller diameter than first body 1 so that second body 2 can be inserted into first body 1. If second body 2 were designed to be solid, it would completely interrupt the water flow in the lower position in the same way as first body 1 in the closed position. However, second body 2 is designed so that it cannot completely interrupt the water flow. This is achieved by the openings 3 in the wall of second body 2 through which the water flows when second body 2 is in the lower position (FIG. 5). In this way, second body 2 acts as a throttle in its lower position, that is when it is located in the water path. The simplest way to achieve this reaction is if the wall of second body 2 is provided with evenly distributed holes with a suitable diameter. However, suitably dimensioned slots or otherwise configured openings 3 are also conceivable. It is also conceivable that the openings 3 are not evenly distributed.

FIG. 2 shows another exemplary embodiment of a ring gate formed according to the present invention. The identifications are consistent with identifications in FIG. 1. The embodiment in FIG. 2 differs from the in FIG. 1 only in that second body 2 has a larger diameter than first body 1. Other than that, the placement of the bodies relative to one another is consistent with the illustration in FIG. 1.

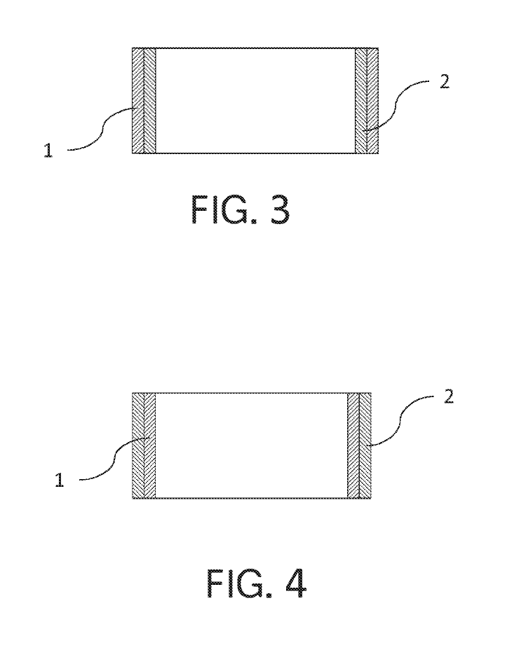

FIGS. 3 and 4 show the respective embodiments of FIGS. 1 and 2, whereby now the two bodies are completely inserted into one another. When the two bodies are completely inserted into one another the ring gate can be either in the open or in the closed position, depending on whether first body 1 is in the open or in the closed position. Based on the two relative arrangements in FIG. 1, 2, 3 or 4, the mode of action of the ring gate formed according to the present invention can now be discussed in further detail.

During normal operation of the hydraulic machine when the ring gate is completely open, the two bodies 1 and 2 are arranged relative to one another as shown in FIG. 3 or 4 and first body 1 is in its open position which indicates that second body 2 is also not located in the water path. If the ring gate is to be closed, for example in an emergency closure, second body 2 is initially moved into the water path. This results in an arrangement according to FIG. 1 or 2. Second body 2 can be moved relatively quickly into the water path since, due to the openings 3 in the wall of second body 2 only throttling of the through-flow occurs. The risk of a damaging pressure surge is much lower than when moving a conventional ring gate into place which completely interrupts the through-flow. When second body 2 is completely moved into the water path, first body 1 is moved into the closed position. This movement can also be accomplished more quickly, since the water flow was already throttled somewhat during the movement of second body 2. When first body 1 has reached its closed position, the bodies are again positioned relative to one another according to FIG. 3 or 4. In this arrangement, first body 1 closes the openings 3 in second body 2, thus interrupting the water flow.

By distributing the closing process onto the movements of the two bodies 1 and 2, a clear linearization of the closing characteristic results. The degree of linearization can be influenced by the size, the location and the distribution of the openings 3 in the wall of second body 2. An optimum dimension and distribution of the openings 3 in the wall of second body 2 can be determined easily through simulation calculations. It is useful if fewer openings 3 per surface area are positioned near the edge of second body 2 that is first moved into the water path (meaning the edge of second body 2 that is adjacent to the water path when second body 2 is outside the water path). With such a distribution, the closing characteristic during the movement of second body 2 as well as during the subsequent movement of first body 1 becomes more linear compared to the case where the openings 3 in the wall of second body 2 are homogeneously distributed. A similar effect can also be achieved if the size of the openings 3 in the direction of the edge which is moved first into the water path becomes smaller (in the case of homogeneous distribution). The two variations could also be combined, meaning that the size of the openings 3 as well as the distribution of same can be varied.

To ensure that second body 2 can efficiently carry out its throttle function, the ring gate may be designed in such a way that, when second body 2 is in the water path, no appreciable volume of water can flow through the hydraulic machine without passing through the openings 3 of second body 2. This can happen through suitable seals that are arranged so that they prevent such a water flow bypassing the openings of second body 2.

In another exemplary embodiment, first body 1 as well as second body 2 have openings 3 in the respective walls. In this case, the openings 3 must however be arranged in such a way that complete interruption of the water flow can occur. This implies that the distance between the two hollow cylindrical bodies may only be very small and that no openings 3 in first body 1 may overlap with openings 3 in second body 2 if the bodies are arranged as shown in FIG. 3 or 4. Since these conditions are very difficult to achieve technically (in particular the almost zero distance between the two bodies) a design providing a first solid body 1 is useful. Also, in the latter case (meaning, with solid first body 1) the distance between the two bodies should not be too large, since in this case (that is, if the distance is not too great) throttling of the water flow during movement of first body 1 can be strongly coupled to the travel of first body 1. The general rule applies that the distance between first body 1 and second body 2 should be less or equal to the smallest width of the openings 3 in second body 2. It is however to be noted, that even if this condition is not met a linearization of the closing characteristic can occur, it will however not be ideal. The problem of the distance can also be solved with the assistance of seals between first body 1 and second body 2. Such seals may be provided, for example, at the upper edge of second body 2 and at the lower edge of first body 1. When sliding the two bodies into one another, a water flow through the openings 3 of second body 2 which are already covered by first body 1 can be prevented by such seals, thus improving the linearization effect.

In another exemplary embodiment, the two bodies are not hollow cylinders. They could also have a cross section deviating from a circle, for example they could be oval. The only prerequisite in regard to the shape of the bodies for functioning of the hitherto described embodiments is that the two bodies can be inserted into each other in an axial direction. One shape is the hollow truncated cone. Both bodies may have such a shape, or only one of the two, as long as the bodies can be inserted into one another. In yet another exemplary embodiment, the conical shape can be selected so that an occurring radial deformation can be countered through water pressure (greater rigidity). Since the pressure acts predominantly at the end of the bodies that first enter the water path, a deformation can also be accepted in that the bodies have a larger diameter there which is flexibly reduced again by the water pressure. In this way it can also be achieved that the gap between the two bodies effectively remains approximately constant during closing.

In yet another exemplary embodiment, first body 1 and second body 2 have congruent openings 3. Both bodies are simultaneously moved into the water way during closing, wherein the bodies are aligned relative to one another in such a way that the water can flow through the congruent openings 3 (meaning that during this movement they are positioned relative to one another according to FIG. 3 or 4). The water flow is thereby throttled. The two bodies are then turned relative to one another so that the openings 3 in both bodies respectively are covered by the wall of the other body, thus interrupting the water flow. The dimension and distribution of the openings 3 in both bodies must therefore be designed to make this possible. In this embodiment, first body 1 is in the open position if it is not in the water path and first body 1 is in the closed position when it is in the water path and is aligned with second body 2 in such a way that the openings 3 in both bodies respectively are covered by the wall of the other body. Another embodiment has both bodies designed conically, in other words in the shape of a hollow truncated cone. This renders the bodies more rigid. This is useful since a deformation of the ring gate during closing can lead to jamming of same with disastrous consequences.

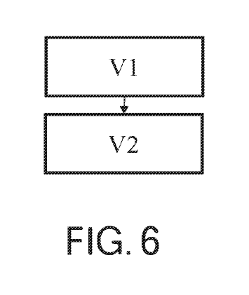

FIG. 6 illustrates the sequence of the process steps of the closing procedure according to an exemplary embodiment of a method provided according to the invention. The movement of second body 2 into the water path is identified with V1 and the movement of first body 1 into the closed position is identified with V2. The process steps may be implemented in this sequence.

In another exemplary embodiment of the method, the movement of first body 1 (V2) can already start while the movement of second body 2 (V1) is not yet fully completed. Generally, V1 must start before V2 starts and must be completed before V2 is completed in order to thus ensure linearization according to the invention. The respective start and end times and the speeds of the movements of first body 1 and second body 2 can be determined through simulation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hydraulic machine having a rotor, a spiral and a ring gate for interrupting a water flow through a water path of the hydraulic machine, the ring gate comprising:
a first hollow body extending around a rotor axis and being configured to move from an open position into a closed position and back in an axial direction, whereby water flow through the hydraulic machine is prevented when the first body is in the closed position; and
a second hollow body extending around the rotor axis and being configured to move from a first position outside of a water path into a second position within the water path and back in the axial direction, the second hollow body further including a plurality of openings in a wall through which the water flow flows when the second hollow body is in the second position and the first hollow body is not in the closed position.

2. The hydraulic machine according to claim 1, wherein an inner diameter of the first hollow body is larger than an outer diameter of the second hollow body.

3. The hydraulic machine according to claim 1, wherein an outer diameter of the first hollow body is smaller than an inner diameter of the second hollow body.

4. The hydraulic machine according to claim 1, wherein the plurality of openings in the wall of the second hollow body are homogeneously distributed.

5. The hydraulic machine according to claim 1, wherein the plurality of openings in the wall of the second hollow body are heterogeneously distributed.

6. The hydraulic machine according to claim 5, wherein the plurality of openings in the wall of the second hollow body are arranged such that a portion of the plurality of openings per surface area near a first edge of the second hollow body that is adjacent to the water path when the second hollow body is in the first position is greater than near a second edge opposite the first edge of the second hollow body.

7. The hydraulic machine according to claim 1, wherein the plurality of openings in the wall of the second hollow body are of the same size.

8. The hydraulic machine according to claim 1, wherein some of the plurality of openings in the wall of the second hollow body have a first size and some of the plurality of openings in the wall of the second body have a second size that is different than the first size.

9. The hydraulic machine according to claim 8, wherein the plurality of openings having the first size are near an edge of the second hollow body that is adjacent to the water path when the second hollow body is in the first position and the plurality of openings having the second size are near another edge of the second hollow body, the first size being less than the second size.

10. The hydraulic machine according to claim 1, wherein at least one of the first hollow body and the second hollow body have a hollow cylindrical shape.

11. A method for closing a ring gate of a hydraulic machine, the method comprising:
providing the ring gate having a first hollow body extending around a rotor axis and being configured such that it moves from an open position into a closed position and back in an axial direction, whereby no water flow through the hydraulic machine occurs if the first body is in the closed position; and a second hollow body extending around the rotor axis and being configured such that it moves from a first position outside of a water path into a second position within the water path and back in the axial direction, the second hollow body further including a plurality of openings in a wall through which the water flows when the second hollow body is in the second position and the first hollow body is not in the closed position;
moving the second hollow body from the first position into the second position; and
moving the first hollow body from the open position into the closed position, whereby movement of the second hollow body starts before movement of the first hollow body starts and movement of the second hollow body into the second position completes before movement of the first hollow body into the closed position completes.

12. The method according to claim 11, wherein movement of the first hollow body starts only when movement of the second hollow body is completed.
